(19) United States
(12) Patent Application Publication
(10) Pub. No.: US 2007/0226228 A1
(43) Pub. Date: Sep. 27, 2007

(54) System and Method for Monitoring Service Provider Achievements

(76) Inventors: Horng-Wei Her, St. James, NY (US); Junne Ma, Smithtown, NY (US); Chiu Man Lam, Plainview, NY (US); David C. Dwyer, Rocky Point, NY (US); Kaihu Chen, Lake Grove, NY (US)

Correspondence Address: BAKER BOTTS L.L.P., 2001 ROSS AVENUE, SUITE 600, DALLAS, TX, 75201-2980, US

(21) Appl. No.: 11/419,728

(22) Filed: May 22, 2006

Related U.S. Application Data
(63) Continuation of application No. 11/234,679, filed on Sep. 23, 2005.
Application No. 11/234,679 is a continuation of application No. 11/028,427, filed on Jan. 3, 2005, now abandoned.
Application No. 11/028,427 is a continuation of application No. 10/800,506, filed on Mar. 15, 2004, now abandoned.
Application No. 10/800,506 is a continuation of application No. 10/081,162, filed on Feb. 20, 2002, now abandoned.
(60) Provisional application No. 60/270,043, filed on Feb. 20, 2001.

(51) Int. Cl. G06F 17/30

(52) U.S. Cl. 707/10

(57) ABSTRACT

A method for monitoring service levels of a service provider includes defining performance criteria, deploying at least one data collection agent and executing each data collection agent to monitor and collect operation data. The method further includes receiving the operation data from each data collection agent and aggregating the operation data. A level of service is then determined based on the performance criteria and the aggregated operation data. A system and computer-readable storage media for monitoring service levels of a service provider are also disclosed.

### RELATED APPLICATIONS

This application claims priority to U.S. Provisional Application Ser. No. 60/270,043 filed Feb. 20, 2001, entitled “System and Method For Monitoring Service Levels of an Application Service Provider”, which is incorporated herein by reference in its entirety.

### TECHNICAL FIELD

The present application generally relates to the field of monitoring information over a network. More specifically, the present application relates to systems and methods for monitoring service provider performance in network based service hosting environments.

### BACKGROUND

Network based service hosting is a business model, in which one company offers software hosting services, e.g., application hosting services, to other companies, so that those companies no longer have to support software and hardware used to perform business related operations. In such a business relationship, the service to be provided and the quality of service to be performed are defined in a contractual document called a service level agreement (“SLA”).

Businesses that offers such services are typically referred to as service providers. In traditional service provider business relationships, the service provider's compensation is based on flat fee arrangements. Service provider customers currently measure their provider in terns of system up-time, bandwidth, scalability, security and problem resolution. Further, it is anticipated that in the future service provider customers will measure their providers in terms of, for example, cost savings, cycle time reduction, customer retention and supply chain efficiency. In order for a service provider to convince customers or potential customers that it has satisfied or can satisfy specified service tasks and levels of service quality,. the service provider is often. asked to provide evidence that the services provided have been consistent with the SLA. Without credible evidence, enforcement of the SLA becomes difficult, and thus customers are reluctant to stay in such business relationships or to enter into such business relationships.

A need therefore exists for methods and systems that monitor service provider performance and facilitate a translation of such performance to customer expectations.

### SUMMARY

The present .application provides methods and systems for monitoring service provider performance in a computer processing environment. According to one aspect of the disclosure, a method for monitoring service provider performance is disclosed. The method includes. defining performance criteria and deploying at least one data collection agent. Each deployed data collection agent is executed to monitor and collect operation data, and the operation data from each of the data collection agents is received and aggregated. The method further includes determining a level of service based on the performance criteria and the aggregated operation data.

A system for monitoring service provider performance is also disclosed. The system includes a means for defining performance criteria and a means for collecting data. Each deployed data collection agent is executed to monitor and collect operation data, and the operation data from-each of the data collection agents is received and aggregated. The method further includes determining a level of service based on the performance criteria and the aggregated operation data.

Computer-readable storage media are also disclosed which include processing instructions for implementing certain disclosed methods.

The disclosed systems and methods enable managing, metering and reporting service levels of a service provider. The objects, features and advantages of the proposed method and system are readily apparent from the following description of the preferred embodiments when taken in connection with the accompanying drawings.

### BRIEF DESCRIPTION OF THE DRAWINGS

For a more complete understanding of the described systems and methods, reference is now made to the following description taken in conjunction with the accompanying drawings in which like reference numbers indicate like features and wherein:

FIG. 1 is a block diagram illustrating an exemplary service provider system;

FIG. 2 is a block diagram illustrating a system for monitoring the performance of a service provider in accordance with one embodiment of the disclosure:

FIG. 3 is a block diagram illustrating components one embodiment of the data director of FIG. 2;

FIG. 4 is a functional block diagram of a process for monitoring service provider performance including service level management and service metering methodologies in accordance with one embodiment of the present disclosure.

FIG. 5 is an exemplary flow diagram of a service metering methodology for monitoring the performance of a service provider in accordance with one embodiment of the disclosed method; and

FIG. 6 is an exemplary menu hierarchy of one embodiment of a service level management application.

### DETAILED DESCRIPTION

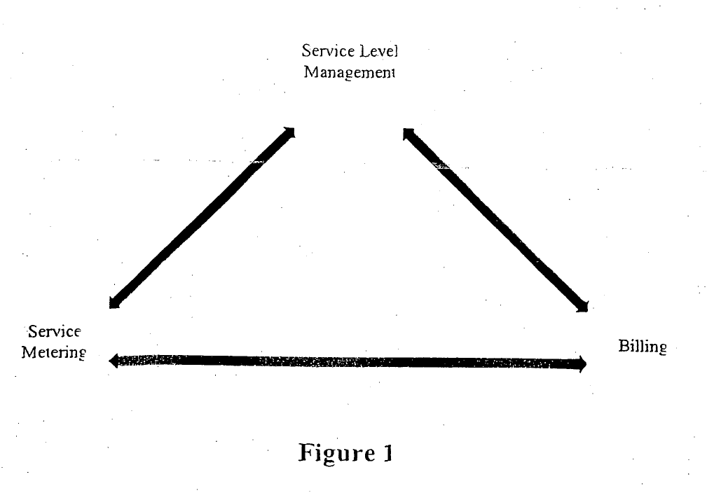

FIG. 1 is an exemplary service provider system that includes service level management, service metering and billing applications that can be interactively used to set up a service provider relationship with customers, monitor the achievements of the service provider and the billing of customers based on the achievements met by the service provider. The service provider system according to the present disclosure can be utilized for any type of network based service provider. Examples of such include internet service providers (ISP's), application service providers (ASP's) and management service providers (MSP's).

The relationship between the service provider and the customer is defined by an agreement known as a service level agreement (SLA). An SLA is a contract between a service provider and a customer that outlines the service or services to be provided and the level at which such service is to be provided. That is, the SLA defines the rights and responsibilities of the service provider and the customer regarding the service to be provided. Typically, in the service provider system according to the present disclosure, the service provider agrees to provide certain specified levels of service, and the customer agrees to compensate the service provider based on the level of service actually provided.

Within or associated with an SLA is a list of one or more conditions or objectives, known as service level objectives (SLOs) , that define the level of service the service provider agrees to provide to the customer. Examples of such objectives include service provider system availability and accessibility, and metrics associated with- the performance of the services to be performed. The SLO are generally based on the level of service desired or required by the customer and the levels of service that the service provider is able or willing to provide. it should be noted that the SLOs may vary depending upon the service being provided and possible the terms of the SLA.

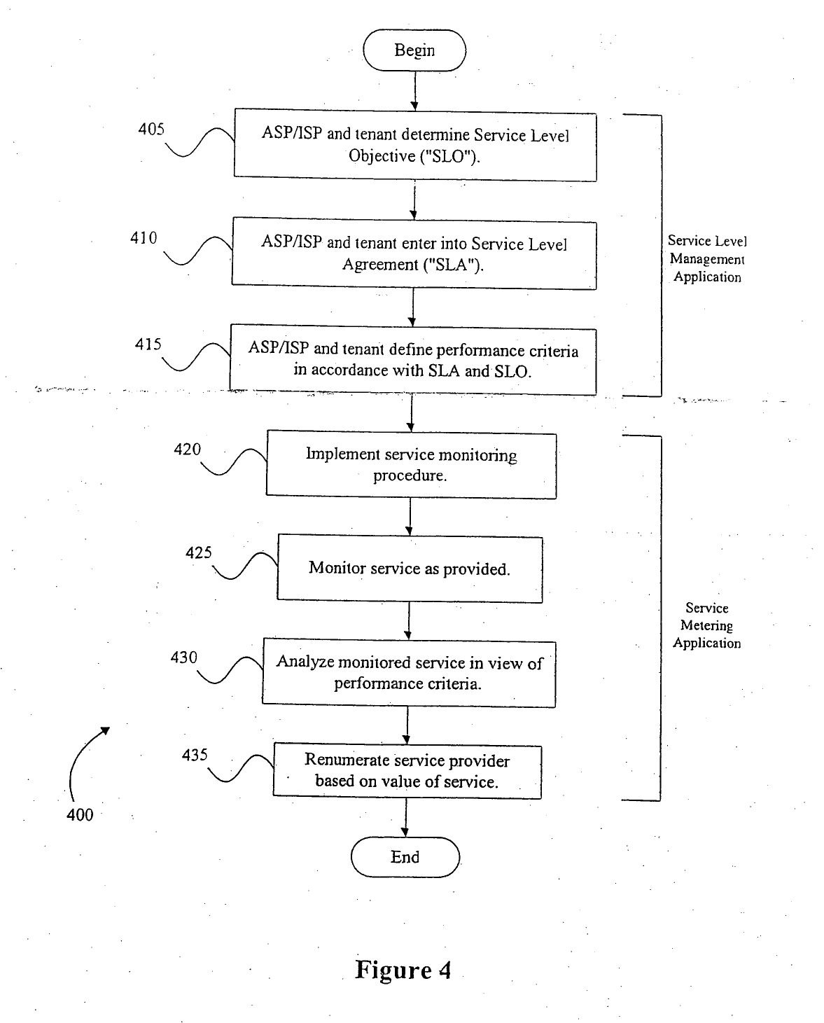

Referring now to FIG. 4, the methods and systems disclosed herein employ methodologies for service level management and service metering which can be used to -monitor the performance of service providers in relation to a service level agreement. A Service Level Agreement (SLA) is a contract between a client/tenant and a service provider that outlines the service to be provided and the quality of the service to be provided by the provider. The methods and systems described herein can be utilized for any type of network based service provider. Examples of such include internet service providers (ISP's), application service providers (ASP's) and management service providers (MSP's).

Early in the service provider—customer relationship, the service provider and the customer typically determine the Service Level Objectives (405). Service Level Objectives (SLO) are a list of operation conditions that define the quality of services to be provided, such as for example, the availability, accessibility and performance of the services to be performed. The SLO are generally based on the level of service desired or required by the customer. and the levels of service that the service provider is able or willing to provide.

The SLO form the basis for a SLA between the service provider and the customer (410). The SLA defines the rights and responsibilities of the service provider and the customer regarding the service to be provided. Typically, the service provider is obligated to provide certain specified levels of service, and the customer is obligated to pay the service provider based on the level of service actually provided.

In order to objectively evaluate the level of service provided by the service provider. the service provider and customer define a set of quantifiable performance criteria in accordance with the SLO and SLA (415). Typically, the performance criteria is designed to ensure that the customer is provided with a level of service above or below a certain minimum threshold. For example, the customer may request service within a particular maximum response time, or the customer may request that an application be accessible for a minimum amount of time per day. Further, the performance criteria should be designed to include events or conditions that can be documented or otherwise verified so that the customer and service provider can be satisfied with the service provider - customer relationship.

Once the service levels and performance criteria have been defined, a service monitoring procedure is implemented (420) and the service is monitored, accordingly (425). The service is monitored throughout the term of the SLA and analyzed in view of the performance criteria (430). Once the actual level of service is determined, the service provider may be renumerated based on the value of the service, as defined in the SLA (435).

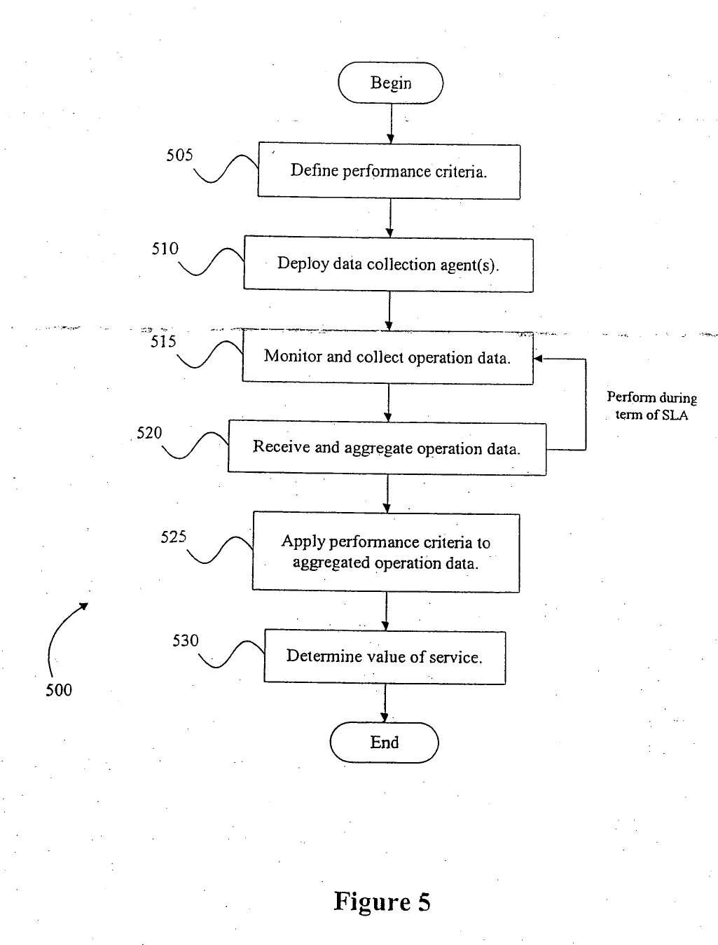

Referring now to FIG. 5. a flow diagram of the service level management methodology in accordance with the present disclosure. The service level management methodology (which can be implemented by a software based service level manager) defines the performance criteria (505) from the SLA. The service level management application performs the functions of blocks 405-415, resulting in defined performance criteria. The defined performance criteria may relate to any number of a variety of metrics that may measure performance. In one embodiment, the performance criteria may relate, for example, to criteria associated with a specific group of users, a particular business function or a specific application.

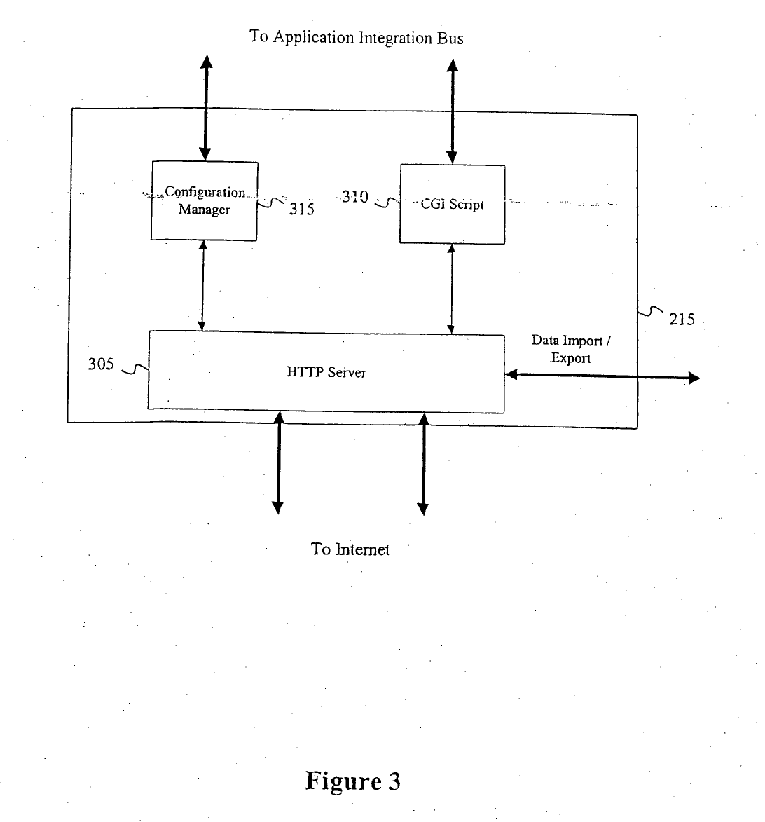

The service metering software application performs the functions of blocks 420-435 illustrated in FIG. 4. The service metering software application includes one or more data collection agents that are deployed throughout the system to be monitored (510). Each data collection agent is configured to monitor the operation of at least a portion the system based on the performance criteria, and collect operation data for use in evaluating the system performance (515). Throughout the term of the SLA, each data collection agent periodically transmits the collected operation data to a data director 215, discussed in greater detail with reference to FIG. 3, which receives and aggregates the collected operation data (520).

The service metering software application analyzes the performance of the service by applying the performance criteria to the aggregated operation data (525), and a value of the service is determined (530). The application of the performance criteria to the aggregated operation data may be accomplished in any of a number of ways depending on the nature of the aggregated operation data obtained. For example, if the aggregated operation data represents an average of operating values, it may be compared to a minimum acceptable average defined by the performance criteria. In another example, if the aggregated operation data represents the presence or absence of an unacceptable operating condition, the aggregated operation data may be tested in accordance with the performance criteria.

The value of the service may be reported to the service provider and/or the customer in a number of ways. For example, the service provider may receive the value of the service and may incorporate the value into a billing statement provided to the customer. Alternatively, the value of the service, the performance criteria and/or the aggregated operation data may be incorporated into a hardcopy report that may be provided to both the service provider. and the customer.

Operating Environment

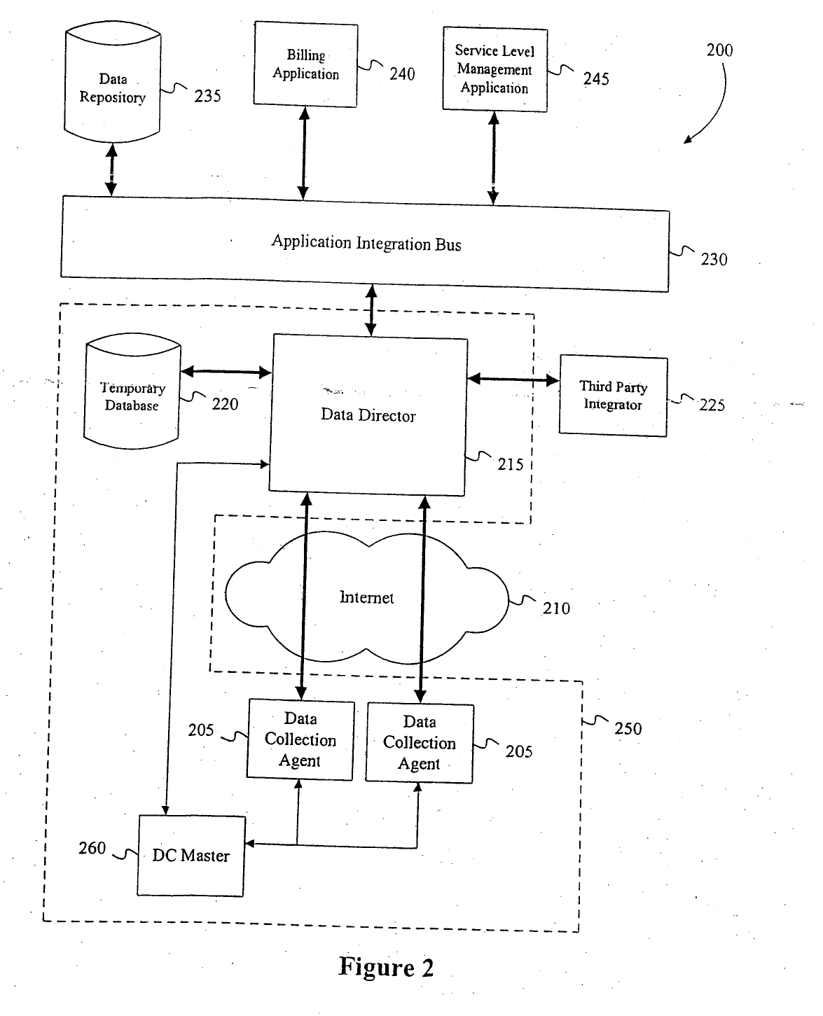

Referring now to FIG. 2, a block diagram of an exemplary service provider system for monitoring service provider performance is provided. Generally, the system includes a data repository 235, a service level management application 245, and a service metering application 250 that communicate through an application integration bus 230. The service level management application 245 stores and/or retrieves data defining the service level agreement, service level objectives and performance criteria to and/or from the data repository 235.

The application integration bus 230 of the system 200 is capable of storing information to and retrieving information from a variety of disparate sources including, for example, the data repository 235, and billing application 240. The application integration bus 230 is an infrastructure that facilitates communication between different computer programs in a consistent and reliable manner. An example of a suitable application integration bus is the CA Common Services application, formerly known as Jasmineᵢᵢ, manufactured by Computer Associates International Inc., Islandia, N.Y.

The service metering application 250 includes one or more data collection agents 205 that monitor the metrics associated with the performance criteria and collect system operation data. Each data collection agent 205 may utilize different technology to collect data according to predetermined metrics. For example, a data collection agent 205 may monitor CPU usage of a workstation while another data collection agent 205 may monitor an application's failure rate. Data collected by one agent can be used for one or many metrics. The amount of operation data collected by the data collection agents 205 is scalable based on the number of data collection agents 205 associated with the system. Data collection agents 205 may be deployed when the system is originally configured, or may be added or removed dynamically during operation of the system.

Each data collection agent 205 of the service metering application 250 may be configured to monitor a specific component or group of components in the service provider architecture. Examples of the categories of components that may be monitored include, for example, applications, platforms, operational components and/or network components. There may be sub-categories of components for which metrics are monitored that are different from or more detailed than the basic category. For example, there may be several sub-categories in the applications category, such as an E-mail sub-package, an ERP sub-package, or an accounting package, to name a few. The definition of each category or sub-category enables the service metering application 250 to monitor application specific metrics, which may only be available from a particular type of application.

The operation data collected by the one or more data collection agents 205 is forwarded to a data director 215. The data director 215 receives the operation data from the data collection agents 205, performs an initial level of data aggregation and generates SLO for particular metrics.

In addition to aggregating the operation data, data director 215 may also redirect raw or consolidated data/events to other components, such as billing application 240 and/or service level management application 245. The redirected data may pass through the application integration bus 230, or may be transmitted to a third party integrator 225 through, for example, a publish and subscribe model interface. The data director 215 further provides management and configuration capability to data collection agent(s) 205 within the package and provides feedback to a management system regarding the status of components.

The illustrated system includes a single data director 215, but alternative embodiments may include more than one data director 215 depending on the number of data collection agents 205 and the workload. The illustrated system further shows that the data director 215 has its own temporary database 220 for storing small interval. aggregated data. The service metering application 250 can operate in a standalone mode for limited data-gathering for a service provider, or it can work in an integrated data feed mode for other products such as billing application 240 and service level management application 245. The service metering application 250 may include an interface to pull data from the data director 215 for batch processing or in a register callback mode to push data out to a requester for real time events.

For billing application 240, usage data or billable data may be available from different sources. in one embodiment, the output is in XML to provide a flexible data exchange format. For service level management application 245, initial aggregated operation data may be available for to evaluate the SLA. Certain SLO violation events may also be available.

In the illustrated embodiment, the service metering application 250 is well suited for an ASP aggregator because data can be transferred from multiple ASP's to the aggregator in XML format through the application integration bus 230. The service metering application 250 also includes technology to help a client verify the quality of service provided by a service provider, such as, for example, user response time and system accessibility. The service metering application 250 may also provide sample SLA templates using the predefined SLO's from a base package.

The data collector master 260 (“DC Master”) is a system component that is responsible for monitoring requests from the data collectors 205 to the data director 215. The DC Master 260 reports heartbeat information to the data director 215, and can start. stop or reset any data collector 205 based on command(s) from a configuration manager 425 of the data director 230. Every data collector 215 is monitored by a DC Master 260. Although a single DC Master 260 is illustrated, a system may include more than one DC Master 260 to accommodate a higher-workload.

Referring now to FIG. 3, there is illustrated a more detailed view of the data director 215. In the illustrated embodiment, data director 215 includes HTTP server 305, CGI Script 310 and configuration manager 315. HTTP server 305 may be conventional web server, and it facilitates communication with data collection agent(s) 205 and/or third party integrator 225.

Configuration manager 315 is responsible for handling requests from service level management application 245 and billing application 240 received via the application interface bus 230. Configuration manager is further responsible for managing the aggregation of. operation data and the transfer of raw and aggregated operation data to the data repository 235. The aggregation and transfer of operation data is actually performed by CGI script 310 at. the direction of configuration manager 315. The CGI script 310 further handles data requests to and from the service metering application 250, and maintains the integrity of the data repository 235 after every interval, for example, deleting outdated data.

External access to data repository 235 is also managed by configuration manager 315. An authorized party, such as third party integrator 225, may request access to the data repository via configuration manager 315. Such access may be provided via an HTTP or other communication means, and may be subject to certain security procedures, such as providing a login ID and password.

Service Level Management Overview

The service level management application 245 is designed for a service provider environment and enables management of business objectives and transactions, not just of system resources. It also provides role-based views to interface with the application. To perform these business activities, the service level management application 245 utilizes and maintains business objects, such as for example, contracts between a customer and a service provider. The application allows an ASP administrator, for example, to create customized SLA offering packages, handle the contract and offering package changes, define new users and user groups, and remove a user from the system, among other things.

The described service level management application is designed to apply to a variety of aspects of a service provider's business model, and it offers a number of features from a user's point of view. For example, a user can define a combination of service level goals, or may simply select from a pre-defined list. Another exemplary feature of the service level management application is that it supports negotiation of the SLA. If the service provider desires, the user can have the freedom to define multiple aspects of the SLA, including, for example, service level goals, legal terms, fees and operation exceptions. Yet another feature is that a user can sign up multiple contracts for different user groupings. or business functions.

From a administrator's point of view, the application supports management of users and user groups. SLA contract administration and management is also supported, enabling a-service 30′ . provider to offer many different contract templates. The service level management application further supports branding, enabling a service provider to brand all the SLA GUI and reports with a customer's identity.

The service level management application handles a variety of SLO syntax and logic. In addition, the application components are self-managed, with detailed logging and “progress pointers” built in. In case of system failure, the system can recover and continue the data processing without losing any data.

The described service level management application is designed to fulfill the need for a service provider to provide a precise SLA offering to its customers. The system supports the end-to-end operation of this business offering. The application interfaces with a service-metering software application to gather usage, performance and operation information, preserve objective service level data, and process. the SLO's based on the contract. The application also interfaces with the customer of the system to present a precise SLA statement through reports.

The application is scalable from a very small. service provider setup, to an extremely large service provider operation. In one embodiment, such scalability is achieved using a distributed and parallel processing design to allow multiple components to work together to complete the data processing.

Role-based SLA Processing

A number of different configurations are possible based on the role of the user. The service level management application processes the related information, and presents the SLA reports. The application supports a number of business relationships between a service provider and, for example, an end-user, and enterprise organization, another service provider, an ASP aggregator, an ISP/NSP, an ISV, or a system vendor.

Distributed Processing Engine

The service level management application can be deployed to a service provider of any size. Typically, the application will be deployed to a single machine, which accesses the service metering database locally or remotely.

In a larger environment, it-is possible that-a single computer will not have enough throughput to complete schedule tasks. The application enables partitioning of the contract data and assigning some data to a distributed SLA engine for processing. A single contract and service definition database may serve this distributed environment so the system does not need to perform difficult synchronization functions among multiple databases.

The SLA engine is designed to process the user subscribed SLO's in near real-time fashion. Shortly after an SLO violation occurs, the application generates an event. Further, the transactions and processes performed by the SLA system may be audited and archived. In the SLA components, the transactions and processing logic is logged in persistent storage before they are processed. Then the process will “sign off” each completed task. This provides the system with a “pointer” of what needs to be processed next. This enables the system be able to recover from a failure without losing or redundantly processing important information.

Provisioning

In some cases, it may be necessary to periodically update the SLA. SLA provisioning can be achieved easily by changing data in the service definition and subscription data tables which contain definitions of metrics to be monitored and associated time frames. The provisioned changes will take effect immediately following the changes. In another words, the SLA provisioning can be achieved in a real-time fashion.

In some cases, since the SLA correlates to a contract, it might be better to implement the provisioning operations at the expiration point of the previous contract, rather than replace the expired contract with the new contract. This situation might also apply to the SLO/metric calculation, threshold values, and service monitoring. The service level management application 245 is able to fulfill both of these cases.

Contract Break Points

Certain changes, such as, for example, changes in the subscription contents, service definition, contract detail or period may effect an SLA report or contract before a contract period expires. To accommodate such changes, the service level management application can register a proper “break point” in the calendar that marks the termination of the existing SLA/contract and starting of the new one. When the application generates the reports, or reviews the contract service level, based on the break point, the application may generate two insistences of outcomes: one for the detail before the change and one for the detail after the change. if necessary, both outcomes may be pro-rated based on the time to reflect the true values of the monitored result.

Time Zones

The service level management application handles multiple time zones driven by an SLA contract, thereby supporting all users in a consistent way regardless of geography. Since a service provider often provides services on a global network, its service may span several geographic locations and operational models. It is possible that a service provider will have a user using the service from any country in the world.

There are many possible approaches to handle time zone issues based on a user's geographic location. One embodiment of the service level management application synchronizes of the interval timestamps to GMT time. Then, based on the service provider “base” user's time zone, the service provider performs all the necessary clock calculations.

For example, assume a user of a service provider signs up a main location in New York. Assume farther that there is a single contract with an SLO that only requires monitoring between 9 am and 5 pm EST. When this user travels to the west coast and accesses the service provider, the service provider may still base performance on the east coast time zone to operate its logic, regardless of whether the user is actually using the service in a different time zone.

Operation Outage Exclusion

The service level management application handles scheduled operation outages, such as on weekends and holidays. If an outage happens during those excluded periods, the “availability” calculation may-exclude those periods in the calculation formula.

Support of Compound SLO Syntax

In most cases, an SLO might look like:
“For App [A], metric [M] will not [operator] than [threshold] based on [interval]”

In some cases the statement above will simply serve as a “first step” of the SLO violation, with another operation dependent upon this state. For example, a violation may be defined as:
“For App [A], metric [M] will not [operator] than [threshold] based on [interval]” AND “When this situation happens [T] times in [interval]”

Another example of an SLO violation definition is:
“For App [A], metric [MI] will not [operator1] than [threshold1] based on [interval]“AND ” For App [A], metric [M2] will not [operator2] than [threshold2] based on [interval2]”

The SLA engine is able to handle both cases. Further, the engine is able to handle any practical number of layers of thresholds and interval checking.

Flexible Offering Packaging

The service level management application provides a service provider administrator the ability to build customized SLO offering packages by grouping metrics, and assigning SLO thresholds and values. The application further enables an ASP to create bundles and pricing schemes to fit the service provider's business goals. in an extreme case, the service provider can even offer a “free form” SLO Packages that gives the service provider user full flexibility for negotiation.

Web-based GUIs

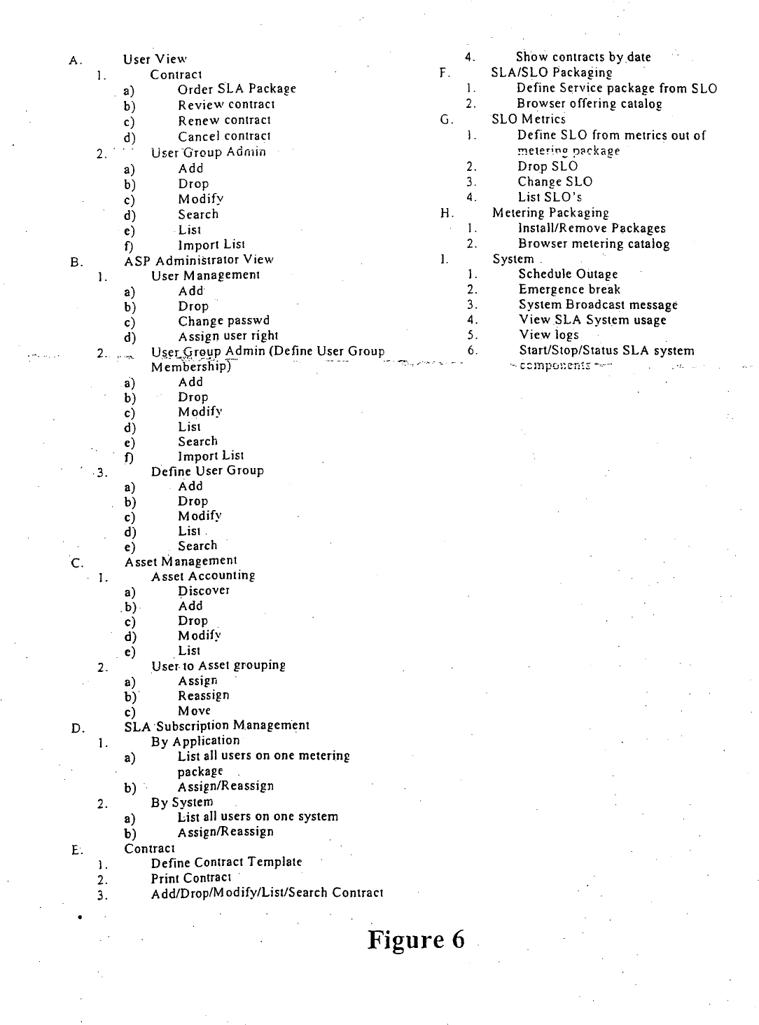

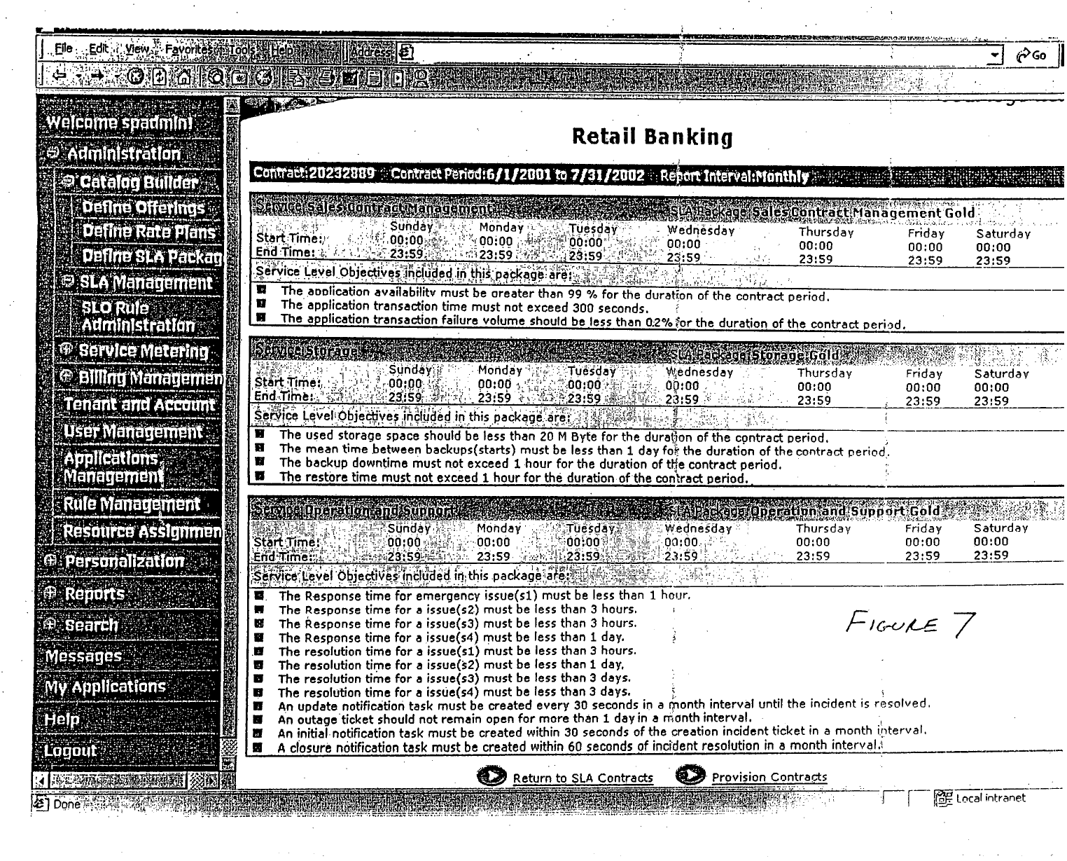

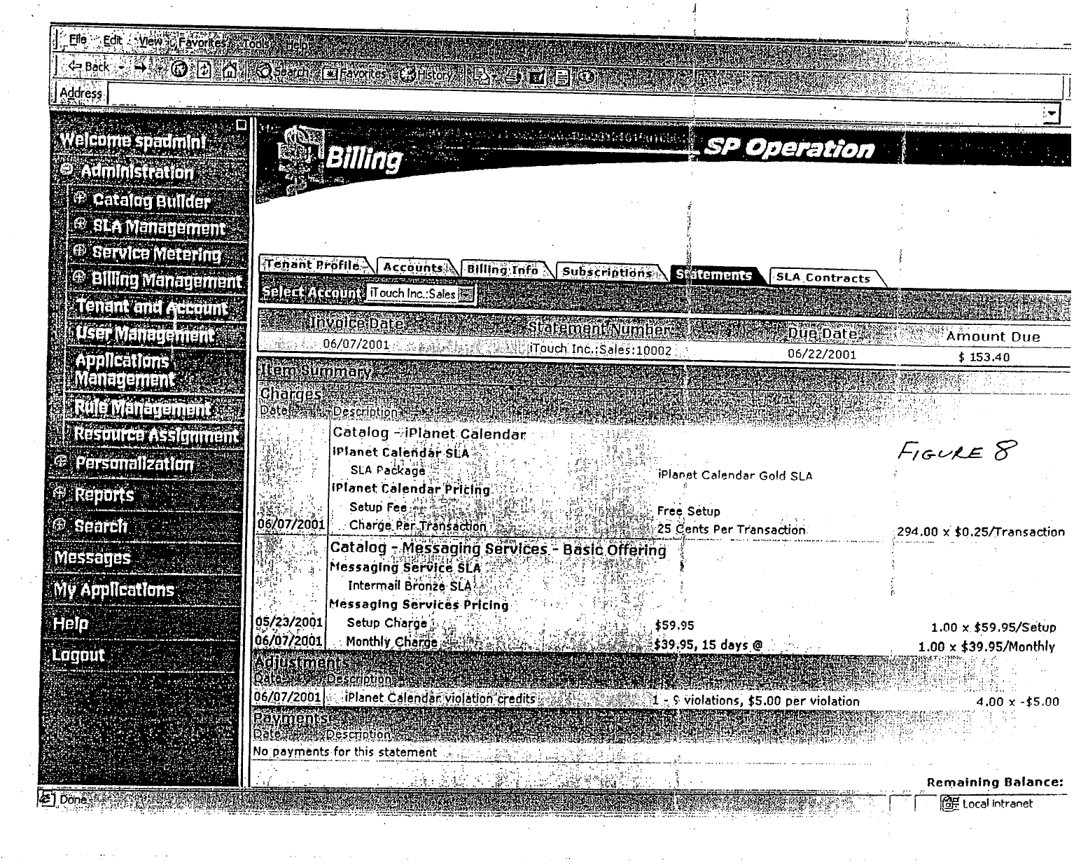

Separate GUIs are available for different users of this system, depending on their roles. FIG. 6 is a menu hierarchy that illustrates an example of the actions that may be taken and the roles that may be defined within the service level management application.

Reporting

The disclosed method and system support web-based SLA reporting to document the performance of a service provider application. Most reports are be prepared at the end of a contract interval to report the service level to the subscribers. Reports supported by the disclosed method and system include, for example, a violation report that contains details regarding SLO violations and measured data values; an SLA Contract report that describes the SLA from a single contract perspective. and a performance report that provides details of performance based on measured data values. FIGS. 7 and 8 illustrate examples of the types of reports that are supported by the disclosed system.

SLA System Capacity

According to the described SLA engine, the SLO/metric processing capabilities may be extended by applying additional service-metering packages. Each service-metering package may define additional monitor technologies and supported metrics. A well defined metric definition document is also supplied by each additional service-metering package, which can be applied to the SLA system.

Service Metering Overview

In one embodiment, the service metering software application 250 is responsible for performing the functions of blocks 420-435. The service metering software- application 250 enables a service provider, and its customers, to gauge the usage and performance of its system. The service metering application 250 also provides substantial data for quantitative analysis, .which reflects the activity of the system. The service metering application 250 may employ any data collection technique(s) which allow the application lo gather useful information from a variety of sources and from different applications.

The service metering application 250 may include a number of pre-defined SLO's to reflect the type of data collected throughout the system. It can be used by ASP aggregator to calculate metrics from multiple ASP's. It can also be used as verification tools for a client and to verify the quality of services provided by a service provider.

The service metering application 250 includes at least one data collection agent 205 and a data director 215. The data collection agent(s) 205 include technology to gather information for multiple metrics including, for example, real time events, transaction data and raw data.

Currently, many service providers charge their clients according to a flat fee. With the described service metering application 250, a service provider may differentiate the level of quality service provided to its client. For example, a service provider may charge by usage of time, number of transactions, duration, or number of bytes transferred. Typically, customers measure their service providers in terms of uptime, bandwidth, scalability, security and problem resolution. In the future, customers may wish to measure their providers in terms of cost savings, cycle-time reduction, and customer retention and supply chain efficiency. The service metering application 250 enables a service provider to match up with present and future customer expectations.

The exemplary service level manage and service metering applications enable management and metering of system resources according to certain categories, such as, for example, application, platform, operation and network.

Although the disclosed systems and methods have been described in terms of specific embodiments and applications, persons skilled in the art can, in light of this teaching, generate additional embodiments, including various changes, substitutions and alterations, without exceeding the scope or departing from the spirit of the disclosure. Accordingly, it is to be understood that the drawing and description in this disclosure are proffered to facilitate comprehension of the systems and methods, and should not be construed to limit the scope thereof.

What is claimed is:

1. A method for monitoring service provider performance, comprising:
defining performance criteria;
deploying at least one data collection agent;
executing each data collection agent to monitor and collect operation data;
receiving the operation data from each data collection agent;
aggregating the operation data;
determining a level of service based on the performance criteria and the aggregated operation data.

2. The method of claim 1 wherein the performance criteria is scalable based on the number of data collection agents.

3. The method of claim 1 wherein the performance criteria includes criteria associated with a group of users.

4. The method of claim 1 wherein the performance criteria includes criteria associated with a business function.

5. The method of claim 1, further comprising deploying at least one additional data collection agent.

6. The method of claim 1, further comprising removing at least one data collection agent from service.

7. The method of claim 1, further comprising converting at least a portion of the operation data based on a regional time zone associated with the portion of the operation data.

8. The method of claim 1 further comprising exporting the aggregated operation data to a third party integrator.

9. The method of claim 8, further including generating a published interface for the aggregated operation data.

10. A system for monitoring service provider performance, comprising:
means for defining performance criteria:
means for monitoring and collecting operation data;
means for receiving operation data;
means for aggregating the operation data; and
means for determining a level of service based on the performance criteria and the aggregated operation data.
